(19) United States
(12) Patent Application Publication
(10) Pub. No.: US 2009/0311933 A1
(43) Pub. Date: Dec. 17, 2009

(54) Flame-retardant low-resilience urethane foam cushion

(75) Inventors: Masahiko Mihoichi, Hyogo (JP); Shigeru Maruyama, Hyogo (JP); Wataru Mio, Hyogo (JP); Susumu Iwade, Osaka (JP)

Correspondence Address: HAMRE, SCHUMANN, MUELLER & LARSON, P.C., P.O. BOX 2902, MINNEAPOLIS, MN, 55402-0902, US

(73) Assignee: Kaneka Corporation, Osaka (JP)

(21) Appl. No.: 11/919,395

(22) PCT Filed: Apr. 17, 2006
(86) PCT No.: PCT/JP2006/308020

§ 371 Date: Oct. 26, 2007

(30) Foreign Application Priority Data
Apr. 28, 2005 (JP) 2005-132494

(51) Int. Cl. B32B 5/18

(52) U.S. Cl. 442/315

(57) ABSTRACT

A low-resilience urethane foam cushion that is comfortable and has high flame retardancy. It sufficiently retains the unique texture and comfort inherent in low-resilience urethane foam materials for use as cushions or pillows. It further retains the intact excellent texture, touch feeling, and other properties inherent in fibrous materials. The low-resilience urethane foam cushion is obtained by covering a low-resilience urethane foam with a flame-barrier fabric made of at least two members selected from the group consisting of halogenated fibers (A), flame-retardant cellulosic fibers (B), cellulosic fibers (C), and polyester fibers (D), wherein the sum of (A) and (B) is 25 to 75 wt. % of the flame-barrier fabric, the sum of (B) and (C) is 30 wt. % or more of the flame-barrier fabric, the amount of (C) alone is up to 75 wt. % of the flame-barrier fabric, and the amount of (D) alone is up to 30 wt. % of the flame-barrier fabric.

### TECHNICAL FIELD

The present invention relates to a flame-retardant low-resilience urethane foam cushion that uses low-resilience urethane used in bedding such as pillows. More specifically, this invention relates to a flame-retardant low-resilience urethane foam cushion in which low-resilience urethane foam is covered with a flame-blocking fabric made of fibers including a flame-retardant fiber.

### BACKGROUND ART

Low-resilience urethane foam is a foam body having a large specific gravity and lots of open cells. It provides sensation such as particular softness and thus has begun to be used in bedding such as pillows and interior fiber products. Conventionally used urethane foam has a small specific gravity, and when subjected to a flame, it burns without generating a melt. On the other hand, when low-resilience urethane foam is subjected to a flame, a melt is generated and seeps from a ticking, thus making it difficult to extinguish burning once the burning is started. Therefore, it is required that low-resilience urethane foam be formed so as to be highly flame-retardant.

Meanwhile, in recent years, bedding and interior fiber products have been demanded to have a sufficiently high degree of flame retardancy such that, for example, even when kept in contact with a flame for a period of time as long as, for example, 20 seconds, they do not burn. Such a degree of flame retardancy is described in, for example, the draft of Technical Bulletin 604 (hereinafter, referred to as TB 604) of the state of California, U.S.A. issued in October 2003, which explains a pillow burning test method. Thus, it is desirable to obtain low-resilience urethane foam bedding or the like that has such a high degree of flame retardancy that, even when kept in contact with a flame for a long period of time, it does not burn. It also is required that bedding and interior fiber products provide comfort in terms of hygroscopicity or the like and is excellent in appearance and texture in addition to having flame retardancy.

Polyester that is a general-purpose material used often in bedding and interior fiber products melts easily and when it burns, does not produce carbides. Therefore, when brought into contact with a flame, polyester melts and burns to cause a hole to be formed, thus failing to maintain its structure. Hence, the property of polyester of preventing a flame from reaching other types of fibers including cotton and low-resilience urethane foam that are used in bedding and interior fiber products is by no means sufficient.

So far, studies have been conducted on various types of flame-retardant fibers and flame prevention agents but have not yet led to the creation of a cushion containing low-resilience urethane foam, which realizes all of the above-described high degree of flame retardancy, comfort and appearance. For example, there is a technique that is a so-called post-treatment flame prevention in which a flame prevention agent is applied to a woven fabric such as a cotton fabric. This technique has been problematic, for example, in that variations in flame prevention performance might occur due to uneven adhesion of the flame prevention agent, in that the adhesion of the flame prevention agent might cause the fabric to be hardened and thus degrade the comfort in terms of touch feeling or the like, and in that the flame prevention agent might come off to degrade the flame prevention performance. Further, a fabric using an inorganic fiber represented by a glass fiber has excellent flame retardancy but is disadvantageous in that fiber-opening hardly can be performed, in that it exhibits poor hygroscopicity and touch feeling, and in that it has poor dyeability. Further, a fabric made of a heat-resistant fiber has excellent flame retardancy but is extremely expensive and is also disadvantageous in that fiber-opening hardly can be performed, in that it exhibits poor hygroscopicity and touch feeling, and in that it has poor dyeability.

Each of Patent Documents 1 and 2 proposes a flame-retardant fiber composite as a combination of a halogen-containing fiber that is made highly flame-retardant by the addition of a large amount of a flame retardant and another type of fiber that is not made flame-retardant. This flame-retardant fiber composite can be used in bedding products and interior fiber products and is a material that is excellent in texture, hygroscopicity and touch feeling and provides stable flame retardancy. The disclosure of Patent Documents 1 and 2, however, does not include the use of the flame-retardant fiber composite described therein in combination with a material that is extremely easily flammable and has a low melting point such as low-resilience urethane foam. Further, there have been proposed a flame-retardant bulky nonwoven fabric that is comprised of an essentially flame-retardant fiber and a halogen-containing fiber (Patent Document 3), a flame-retardant nonwoven fabric that is comprised of a halogen-containing polyacrylonitrile fiber and a fiber that, when they are burned, supports the halogen-containing polyacrylonitrile fiber (prevents the burned fiber from losing its shape) (Patent Document 4), and a flame-retardant nonwoven fabric that is comprised of a flame-retardant rayon fiber or a flame-retardant acrylic fiber or a flame-retardant melamine fiber (Patent Document 5). However, all of these flame-retarding techniques use nonwoven fabrics. Because of this, these techniques have resulted in manufacturing products that lack a soft feel on skin and stretchability such as those of products using knit fabrics and in which texture and sensation particular to cotton and low-resilience urethane foam as materials, which are used in bedding and furniture, are impaired to result in deteriorated comfort of the products.

### Patent Document 1: JP 05 (1993)-106132 A

### Patent Document 2: JP 05 (1993)-093330 A

### Patent Document 3: WO 03/023108

### Patent Document 4: US 2004/0062912 A1

### Patent Document 5: US 2004/0097156 A1

### DISCLOSURE OF INVENTION

### Problem to be Solved by the Invention

It is an object of the present invention to provide a flame-retardant low-resilience urethane foam cushion that, while providing particular softness and sensation, uses flammable low-resilience urethane foam and can be prevented from burning even in a test as specified in TB 604 in which the cushion is kept in contact with a flame for a long time.

It is another object of the present invention to provide a flame-retardant low-resilience urethane foam cushion that exhibits a soft feel on skin and stretchability such as those of a knit product and prevents softness and sensation particular to low-resilience urethane foam from being impaired.

### Means for Solving Problem

In order to solve the above-described problems, the inventors of the present invention conducted vigorous studies to find that the above-described objects can be achieved by using conventionally used fibers such as a modacrylic fiber and a cellulosic fiber.

That is, the present invention relates to the following inventions.

(1) A flame-retardant low-resilience urethane foam cushion in which low-resilience urethane foam is covered with a flame-blocking fabric that is formed by using at least two types of fibers selected from the group consisting of a halogen-containing fiber (A), a flame-retardant cellulosic fiber (B), a cellulosic fiber (C), and a polyester fiber (D). In the cushion, a total amount of (A) and (B) is 25 to 75 wt % with respect to the flame-blocking fabric, a total amount of (B) and (C) is not less than 30 wt % with respect to the flame-blocking fabric, an amount of (C) alone is not more than 75 wt % with respect to the flame-blocking fabric, and an amount of (D) alone is not more than 30 wt % with respect to the flame-blocking fabric. Moreover, a total of a thickness of the flame-blocking fabric and a thickness of a ticking is not less than 1 mm.
(2) The flame-retardant low-resilience urethane foam cushion described in (1), wherein the halogen-containing fiber (A) is a modacrylic fiber.
(3) The flame-retardant low-resilience urethane foam cushion described in (1) or (2), wherein the flame-retardant cellulosic fiber (B) is a fiber that is formed of at least one fiber selected from the group consisting of cotton, hemp, rayon, polynosic, cupra, acetate, and triacetate and contains a flame retardant.
(4) The flame-retardant low-resilience urethane foam cushion described in (3), wherein the flame-retardant cellulosic fiber (B) is a rayon fiber in which a flame retardant selected from silicic acid and aluminum silicate is contained in an amount of 20 to 50 wt %.
(5) The flame-retardant low-resilience urethane foam cushion described in (3), wherein the flame-retardant cellulosic fiber (B) is a fiber that is formed of a cellulosic fiber to which a flame retardant selected from the group consisting of phosphoric ester compounds, halogen-containing phosphoric ester compounds, condensed phosphoric ester compounds, polyphosphate compounds, red phosphorus, amine compounds, boric acid, halogen compounds, bromides, urea-formaldehyde compounds, and ammonium sulfate adheres in an amount of 6 to 25 wt % with respect to the cellulosic fiber.
(6) The flame-retardant low-resilience urethane foam cushion described in any one of (1) to (5), wherein the cellulosic fiber (C) is at least one fiber selected from the group consisting of cotton, hemp, rayon, polynosic, cupra, acetate, and triacetate.
(7) The flame-retardant low-resilience urethane foam cushion described in (6), wherein the cellulosic fiber (C) is cotton.
(8) The flame-retardant low-resilience urethane foam cushion described in any one of (1) to (7), wherein the polyester fiber (D) has a melting point of 200° C. or higher.
(9) The flame-retardant low-resilience urethane foam cushion described in any one of (1) to (8), wherein the flame-blocking fabric contains a flame retardant in an amount of 2 to 40 wt %.
(10) The flame-retardant low-resilience urethane foam cushion described in (9), wherein as the flame retardant, an antimonide is contained in an amount of 2 to 20 wt %.
(11) The flame-retardant low-resilience urethane foam cushion described in any one of (1) to (10), wherein the ticking is a flame-blocking pile knit fabric.
(12) The flame-retardant low-resilience urethane foam cushion described in any one of (1) to (10), wherein a flame-blocking knit fabric is provided on an inner side of the ticking.
(13) The flame-retardant low-resilience urethane foam cushion described in (12), wherein the ticking is a pile knit fabric, and a flame-blocking knit fabric is provided on an inner side of the ticking.
(14) The flame-retardant low-resilience urethane foam cushion described in any one of (11) to (13), wherein a total weight per unit area of the ticking that covers the low-resilience urethane foam is not less than 300 g/m².

### EFFECTS OF THE INVENTION

According to the present invention, a flame-retardant low-resilience urethane foam cushion can be provided that has such a high degree of flame retardancy that, even in a test as specified in TB 604 in which the cushion is kept in contact with a flame for a long time, it is possible to prevent burning from spreading to urethane foam. Further, the flame-retardant cellulosic fiber (B) and/or the cellulosic fiber (C) are contained, and thus it is possible to retain excellent texture and comfort in terms of touch feeling, hygroscopicity and the like that are inherent in these types of fibers.

Moreover, according to the present invention, a flame-retardant low-resilience urethane foam cushion can be provided that has a soft feel on skin and stretchability such as those of a knit product and prevents softness and sensation particular to low-resilience urethane foam from being impaired.

### BEST MODE FOR CARRYING OUT THE INVENTION

The flame-retardant low-resilience urethane foam cushion according to the present invention is characterized by covering internally provided low-resilience urethane foam with a flame-blocking fabric. The flame-retardant low-resilience urethane foam cushion according to the present invention can be used in, for example, pillows, cushions, and headboard cushions for use in a headboard portion of a bed, though there is no limitation thereto.

Herein, the low-resilience urethane foam generally refers to viscoelastic foam that has both elasticity and viscosity, and has properties of a shock-absorbing foam that has a high hysteresis loss coefficient (JIS K 6400-2) compared with flexible urethane foam in general use. Further, the low-resilience urethane foam is characterized by having an impact resilience coefficient as extremely low as not more than 15% (JIS K 6400-3) compared with that of flexible urethane foam in general use. The low-resilience urethane foam used in the present invention is, for example, a material having a pressure dispersion function represented by “Tempur” (registered trademark) (available from Tempur World, Inc.), though there is no limitation thereto. When the above-described low-resilience urethane foam is used in a bedding product, it exhibits characteristics of, for example, having low resilience and dispersing a body pressure, thus fitting the body, having high elastic recoverability and softness, and being excellent in moisture releasability, thus facilitating maintenance. When subjected to a flame, urethane foam in common use burns without generating a melt. On the other hand, when low-resilience urethane foam is subjected to a flame, a melt is generated and seeps from a ticking, thus making it difficult to extinguish burning once the burning is started. Therefore, in the case of using low-resilience urethane foam in bedding or the like, it is required that a high degree of flame retardancy be imparted to the urethane foam.

The flame-blocking fabric used in the present invention may be used in such a manner as to be sandwiched between a ticking in common use that constitutes a surface and low-resilience urethane foam. In this case, the low-resilience urethane foam is covered entirely with the flame-blocking fabric, and the ticking is provided over the flame-blocking fabric. The flame-blocking fabric may be used in the form of a knit fabric. Further, the flame-blocking fabric used in the present invention may be used as a ticking constituting the surface of the low-resilience urethane foam. In this case, the flame-blocking fabric may be used in the form of a knit fabric having a pile surface. Further, a configuration also may be used in which the flame-blocking fabric used in the present invention is used as a ticking, and the flame-blocking fabric of the present invention is sandwiched between the ticking and low-resilience urethane foam, i.e. two flame-blocking fabrics are used in a superimposed state.

The flame-blocking fabric used in the present invention is formed of fibers to which flame retardancy is imparted by the halogen-containing fiber (A) and/or the flame-retardant cellulosic fiber (B) and texture, touch feeling and hygroscopicity are imparted by the cellulosic fiber (C) and/or the flame-retardant cellulosic fiber (B), and that contain the polyester fiber (D) or the like as required. Therefore, the flame-blocking fabric of the present invention contains at least two types of fibers. A method of manufacturing such a fabric is, for example, cotton blending, blending, or interknitting, though there is no limitation thereto.

In the present invention, a flame-blocking property refers to a property that, when subjected to a flame, a flame-blocking fabric is carbonized while maintaining a fiber form to block the flame, thereby preventing the flame from spreading to a portion other than the fabric, such as low-resilience urethane foam. Specifically, a flame-blocking fabric is sandwiched between a ticking and internally provided low-resilience urethane foam or alternatively, a flame-blocking fabric is used as a ticking, and thus in case of a fire, it is possible to keep a flame from reaching the internally provided low-resilience urethane foam so that the expansion of the fire can be contained.

Being in the form of a knit fabric, the above-described flame-blocking fabric can be stretched in an arbitrary direction compared with the case of a woven fabric. Further, a knit fabric is not as thick as a nonwoven fabric and has a small thickness. Therefore, it is preferable that the flame-blocking fabric is in the form of a knit fabric since it can prevent the texture and sensation particular to low-resilience urethane foam as a material from being impaired. Further, generally speaking, a fiber shrinks when it burns to form a carbonized film, so that a crack is likely to be produced in the carbonized film thus produced. In the case of a knit fabric, however, since a knit fabric can be stretched in an arbitrary direction, a crack-less carbonized film of extremely excellent quality can be obtained. Thus, it is preferable that the flame-blocking fabric is in the form of a knit fabric. A method of knitting a flame-blocking knit fabric is not limited particularly and may be either weft knitting or warp knitting. Further, a shape of a knit fabric is not limited particularly and may be a pile knit fabric having a napped surface.

The flame-blocking fabric of the present invention may contain an antistatic agent, a heat coloring inhibitor, a light resistance improver, a whiteness improver, a matting inhibitor or the like as required.

The halogen-containing fiber (A) used in the present invention is a component that is used for improving the flame retardancy of the flame-blocking fabric and has an effect of generating an oxygen-deficient gas when burned thereby to aid self-extinguishing of a flame on the surface. Examples of the halogen-containing fiber (A) used in the present invention include fibers comprised of homopolymers of halogen-containing monomers such as vinyl chloride or vinylidene chloride, copolymers thereof, and copolymers thereof with a monomer copolymerizable with these halogen-containing monomers such as acrylonitrile, styrene, vinyl acetate, or acrylic acid ester, or graft polymers in which a halogen-containing monomer is grafted to a PVA polymer, though there is no limitation thereto. Among these examples of the halogen-containing fiber (A), a modacrylic fiber that is a fiber comprised of a copolymer of a halogen-containing monomer and acrylonitrile is used preferably from the viewpoint of imparting excellent texture and touch feeling as well as flame retardancy to a flame-blocking fabric.

It is preferable that in order to fortify the flame retardancy of a flame-blocking fabric, a flame retardant is added to the above-described modacrylic fiber, and specific examples of the flame retardant include antimonides such as antimony trioxide, antimony pentoxide, antimonic acid and antimony oxychloride, Sn compounds such as stannic oxide, metastannic acid, stannous oxyhalide, stannic oxyhalide, stannous hydroxide and tin tetrachloride, Zn compounds such as zinc oxide, Mg compounds such as magnesium oxide and magnesium hydroxide, Mo compounds such as molybdenum oxide, Ti compounds such as titanium oxide and barium titanate, nitrogen compounds such as melamine sulfate and guanidine sulfamate, phosphorous compounds such as polyammonium phosphate and dibutylaminophosphate, Al compounds such as aluminum hydroxide, aluminum sulfate and aluminum silicate, Zr compounds such as zirconium oxide, Si compounds such as silicate and glass, natural or synthetic mineral compounds such as kaolin, zeolite, montmorillonite, talc, perlite, bentonite, vermiculite, diatomite and graphite, and halogen compounds such as chlorinated paraffin, hexabromobenzene and hexabromocyclododecane. Further, composite compounds such as magnesium stannate, zinc stannate and zirconium stannate also may be used.

These compounds may be used alone or in combination of two or more types. Among these compounds, antimonides are preferable in that when burned, each of them reacts with a halogen atom released from a modacrylic fiber to generate antimony halide and thus exhibits an extremely high degree of flame retardancy. It is preferable that in order to maintain the flame retardancy of a flame-blocking fabric, an antimonide is added to a modacrylic fiber in an amount of not less than 2 wt % with respect to the flame-blocking fabric as a whole. Further, from the viewpoint of preventing the texture and strength of a flame-blocking fabric from being impaired, it is preferable that an antimonide is added in an amount of not more than 20 wt % with respect to the flame-blocking fabric as a whole. Specific examples of a modacrylic fiber include “Kanecaron” available from Kaneka Corporation, though there is no limitation thereto.

The flame-retardant cellulosic fiber (B) used in the present invention is used for improving the flame retardancy of a flame-blocking fabric and for maintaining the strength of the fabric and imparts excellent texture and comfort in terms of hygroscopicity or the like. Moreover, the flame-retardant cellulosic fiber (B) is a component that is effective in forming a carbonized film in case of burning.

Examples of the flame-retardant cellulosic fiber (B) used in the present invention include a flame-retardant cellulosic fiber that is obtained from a spinning dope containing a flame retardant and a cellulosic fiber that is made flame-retardant by, for example, post-treatment in which a flame retardant is used with respect to the fiber. Examples of the former include a silicic acid-containing cellulosic fiber that contains silicic acid or/and aluminum silicate as a flame retardant and a flame-retardant cellulosic fiber that is made to contain a flame retardant of another type when manufactured. Specific examples of a cellulosic fiber as a matrix of the flame-retardant cellulosic fiber (B) include cotton, hemp, rayon, polynosic, cupra, acetate, and triacetate. These fibers may be used alone or in combination of two or more types.

The above-described silicic acid-containing cellulosic fiber contains, as a flame retardant, silicic acid or/and aluminum silicate in an amount of 20 to 50% in the fiber, and normally has a fineness of about 1.7 to 8 dtex and a cut length of about 38 to 128 mm. Specific examples thereof include “Visil” available from Säteri Oy, which contains silicic acid in an amount of about 30% in the fiber, and “Visil AP” available from Säiteri Oy, which contains aluminum silicate in an amount of about 33% in the fiber. Other types of flame-retardant cellulosic fibers include “Lenzing FR” available from Lenzing A.G. A flame-retardant cellulosic fiber is not limited to these types.

Examples of a flame retardant used to make the latter cellulosic fiber flame-retardant by post-treatment or the like include phosphoric ester compounds such as triphenyl phosphate, tricresyl phosphate, trixylenyl phosphate, trimethyl phosphate, triethyl phosphate, cresylphenyl phosphate, xylenyldiphenyl phosphate, resorcinol bis(diphenyl phosphate), 2-ethylhexyldiphenyl phosphate, dimethylmethyl phosphate, triaryl phosphate (trade name: “Reophos”), aromatic phosphoric esters, phosphonocarboxylic amide derivatives, tetrakis hydroxymethylphosphonium derivatives, and N-methyloldimethylphosphonopropionamide, halogen-containing phosphoric ester compounds such as tris(chloroethyl) phosphate, trisdichloropropyl phosphate, tris-β-chloropropyl phosphate, chloroalkyl phosphate, tris(tribromoneopentyl) phosphate, diethyl-N,N-bis(2-hydroxyethyl)aminomethyl phosphate, and tris(2,6-dimethylphenyl) phosphate, condensed phosphoric ester compounds such as aromatic condensed phosphoric esters and halogen-containing condensed phosphoric esters, polyphosphate compounds such as polyphosphoric acid ammonium amide and polychlorophosphonate, polyphosphoric ester compounds such as a polyphosphoric acid carbamate, red phosphorus, amine compounds, boric acid, halogen compounds, bromides, urea-formaldehyde compounds, ammonium sulfate, and guanidine condensed products, and these may be used alone or in combination of two or more types.

It is preferable that a flame retardant as mentioned above is made to adhere in an amount of 6 to 25 wt % with respect to a cellulosic fiber. Further, in order to maintain the flame retardancy of a flame-blocking fabric, it is preferable that the flame retardant is added in an amount of not less than 0.5 wt % with respect to a flame-blocking fabric as a whole. Further, from the viewpoint of preventing the texture of a flame-blocking fabric from being impaired, it is preferable that the flame retardant is made to adhere in an amount of not more than 20 wt % with respect to a flame-blocking fabric as a whole.

The cellulosic fiber (C) used in the present invention is a component that maintains the strength of a flame-blocking fabric, imparts excellent texture and comfort in terms of hygroscopicity or the like, and is effective in forming a carbonized film in case of burning. Specific examples of the cellulosic fiber (C) include cotton, hemp, rayon, polynosic, cupra, acetate, and triacetate, and these fibers may be used alone or in combination of two or more types. Further, among these fibers, cotton, hemp and rayon are preferable from the viewpoints of touch feeling and hygroscopicity.

The polyester fiber (D) used in the present invention can impart excellent texture, touch feeling, product strength, washing resistance, and durability to a flame-blocking fabric. Moreover, the polyester fiber (D) is a flammable fiber in itself but melts when burned, and a melt thereof covers a carbonized film, and thus the polyester fiber (D) is effective in obtaining improved strength of the resulting carbonized film. Since a low melting point component is more easily flammable compared with a high melting point component, in the case of not using a thermally bonded nonwoven fabric, it is preferable to use a polyester fiber having a melting point of 200° C. or higher rather than using low melting point polyester.

In the case of using a thermally bonded nonwoven fabric as a flame-blocking fabric, a low melting point binder fiber having a melting point of 200° C. or lower may be used. Examples of a low melting point binder fiber include a fiber made of low melting point polyester as a single component, a fiber formed by compounding polyester in common use having a melting point of 200° C. or higher with low melting point polyester, and a composite fiber of polyester in common use having a melting point of 200° C. or higher with low melting point polyolefin, and these may be used alone or in combination of plural types. A composite fiber can be a parallel type or core-in-sheath type composite fiber comprised of polyester/low melting point polypropylene, low melting point polyethylene, and low melting point polyester. Generally, low melting point polyester has a melting point of approximately 110 to 200° C., low melting point polypropylene has a melting point of approximately 140 to 160° C., and low melting point polyethylene has a melting point of approximately 95 to 130° C., and these are not limited particularly as long as they have a melting point of approximately 110 to 200° C. and melt adhering capability.

It is preferable that the flame-blocking fabric used in the present invention contains a flame retardant in a ratio of not less than 1.0 wt %. If the ratio of the flame retardant in the fabric as a whole is less than 1.0 wt %, the self-extinguishing capability in case of burning becomes deficient, so that the ability to prevent a flame from reaching low-resilience urethane foam becomes insufficient.

In the present invention, in wrapping low-resilience urethane foam with a ticking including a flame-blocking fabric, from the viewpoint of a flame-blocking property and the viewpoint of preventing the low-resilience urethane foam, which has decomposed and melted due to heat generated in case of burning, from seeping to the exterior, it is necessary that a total of the thickness of the flame-blocking fabric and the thickness of the ticking be not less than 1 mm. When subjected to a flame, urethane foam in common use burns without generating a melt, whereas low-resilience urethane foam generates a melt that then seeps from a ticking, thus making it difficult to extinguish burning once the burning is started. It is preferable that a flame-blocking fabric has a thickness of not less than 1 mm. Further, it is preferable that a total weight per unit area of all of fabrics covering low-resilience urethane foam is not less than 300 g/m². Moreover, from the viewpoint of a flame-blocking property, it is preferable that a weight per unit area of a flame-blocking fabric is not less than 300 g/m².

In the present invention, in order to achieve further improvements in the texture, comfort in terms of hygroscopicity or the like, durability and self-extinguishing property of a flame-blocking fabric, a flame-blocking fabric containing the cellulosic fiber (C) and/or the polyester fiber (D) is used. The respective ratios of the halogen-containing fiber (A), the flame-retardant cellulosic fiber (B), the cellulosic fiber (C), and the polyester fiber (D) are determined depending on the texture, comfort in terms of hygroscopicity or the like, washing resistance, durability, strength of a flame-blocking fabric, degree of formation of a carbonized film, and self-extinguishing rate. The halogen-containing fiber (A) is contained in a ratio of preferably 0 to 75 wt % and more preferably 25 to 75 wt %. The flame-retardant cellulosic fiber (B) is contained in a ratio of preferably 0 to 75 wt % and more preferably 25 to 70 wt %. The cellulosic fiber (C) is contained in a ratio of preferably 0 to 75 wt % and more preferably 5 to 70 wt %. The polyester fiber (D) is contained in a ratio of preferably 0 to 30 wt % and more preferably 0 to 25 wt %. Further, it is assumed that 25 wt %≦(A)+(B)≦75 wt % and 30 wt %≦(B)+(C).

The halogen-containing fiber (A) is a main component of a flame-blocking fabric, which imparts a self-extinguishing property. If the ratio of the halogen-containing fiber (A) exceeds 75 wt %, the ratio of a carbonizable component becomes low, so that the flame-blocking capability becomes insufficient. Further, the flame-retardant cellulosic fiber (B) is a main component that provides a carbonized film when a flame-blocking fabric is carbonized, and it is not preferable that the ratio of the flame-retardant cellulosic fiber (B) exceeds 75 wt % for the following reasons. That is, this case results in poorer touch feeling compared with the case of using a cellulosic fiber that is not made flame-retardant, so that a resulting fabric becomes insufficient in terms of texture and comfort, and also, this case results in considerable deterioration of workability in carding or the like, so that processing hardly can be performed. In order to impart flame retardancy to a flame-blocking fabric, it is necessary that a total amount of the halogen-containing fiber (A) and the flame-retardant cellulosic fiber (B) be not less than 25 wt %. If a total amount of the halogen-containing fiber (A) and the flame-retardant cellulosic fiber (B) is less than 25 wt %, the flame-blocking property, self-extinguishing capability and/or carbonized film forming capability of a flame-blocking fabric become insufficient, resulting in insufficient flame-blocking capability. It is not preferable that an amount of the halogen-containing fiber (A) and the flame-retardant cellulosic fiber (B) exceeds 75 wt % for the following reasons. That is, this case results in a low ratio of a carbonizable component and poorer touch feeling compared with the case of using a cellulosic fiber that is not made flame-retardant, so that a resulting fabric becomes insufficient in terms of texture and comfort.

Furthermore, the addition of the cellulosic fiber (C) allows excellent texture and comfort in terms of hygroscopicity or the like to be imparted and has the effect of improving the flame-blocking capability of a flame-blocking fabric since the cellulosic fiber (C) can be a carbonizable component. The ratio of the cellulosic fiber (C) is set to not more than 75 wt %. It is not preferable that the ratio of the cellulosic fiber (C) exceeds 75 wt % because the content of a burnable component in a flame-blocking fabric becomes high, thus making it impossible to obtain sufficient flame-blocking capability. Further, if a total amount of the flame-retardant cellulosic fiber (B) and the cellulosic fiber (C) is less than 30 wt %, it becomes difficult to impart an excellent texture and comfort in terms of hygroscopicity or the like that characterize a cellulosic fiber.

Moreover, by the addition of the polyester fiber (D), it is made possible to expect that improvements in washing resistance and durability are achieved. Further, the polyester fiber (D) melts to cover a carbonized flame-blocking fabric when burned and thus has the effect of improving the strength of a carbonized film. The ratio of the polyester fiber (D) is set to not more than 30 wt %. It is not preferable that the ratio of the polyester fiber (D) exceeds 30 wt % because due to the easy flammability of polyester, the ratio of a burnable component in a flame-blocking fabric becomes high to deteriorate the flame-blocking property of the flame-blocking fabric.

The flame-blocking fabric used in the present invention contains the halogen-containing fiber (A) and/or the flame-retardant cellulosic fiber (B) as essential components. The halogen-containing fiber (A) has a high self-extinguishing property, and in particular, the halogen-containing fiber (A) containing an antimonide has a property of, when used by being blended with a fiber without a self-extinguishing property, acting on the fiber without a self-extinguishing property to promptly extinguish a flame caught by a fabric. However, the halogen-containing fiber (A) itself is only mildly effective in promoting carbonization, forms a carbonized film that is not so strong, and has a property of shrinking when subjected to a flame. In contrast to this, the flame-retardant cellulosic fiber (B), while having a self-extinguishing property, is only mildly effective in functioning as a flame retardant with respect to a fiber without a self-extinguishing property. However, the flame-retardant cellulosic fiber (B) is strongly effective in promoting carbonization since its matrix is a cellulosic fiber, and is carbonized promptly, so that the degree of shrinkage of the flame-retardant cellulosic fiber (B) when subjected to a flame is low, thereby allowing a stable carbonized film to be formed. Based on the above, the halogen-containing fiber (A) and the flame-retardant cellulosic fiber (B) are combined so that a high self-extinguishing property and a property of being capable of forming a strong carbonized film that can block a flame in case of burning can be imparted to a flame-blocking fabric.

Furthermore, among the examples of the flame-retardant cellulosic fiber (B), a silicic acid-containing rayon fiber presents a problem that the ductility of the fiber is impaired due to the contained silicic acid and thus the fiber might break in processing such as carding. As for a flame-retardant cellulosic fiber that has been subjected to post-treatment, such a fiber is disadvantageous in that after long-time use, a flame retardant comes off to degrade the flame retarding performance, and in that in the case of using the fiber in bedding, since the bedding comes in direct contact with a skin, the coming-off of the flame retardant is not preferable. Further, the flame-retardant cellulosic fiber that has been subjected to post-treatment presents a possibility that a flame retardant comes off due to washing to degrade the flame retardancy considerably. However, in the case where the flame-retardant cellulosic fiber (B) is combined with the halogen-containing fiber (A), the amount of the flame-retardant cellulosic fiber (B) used in a flame-blocking fabric can be reduced, thereby allowing the above-described disadvantages to be solved.

Moreover, in order to prevent a spinning property and washing resistance from being degraded due to the flame-retardant cellulosic fiber (B), a method can be used in which the flame-retardant cellulosic fiber (B) is used in a reduced amount and the halogen-containing fiber (A) and the cellulosic fiber (C) are used in increased amounts. By this method, while the strength of a resulting carbonized film is decreased, flame retardancy can be imparted by the halogen-containing fiber (A), and excellent texture and comfort in terms of hygroscopicity or the like can be imparted by the cellulosic fiber (C).

In a flame-blocking fabric containing each of the components (A) to (D) in the above-described respective ratios, excellent texture and touch feeling, hygroscopicity, and durability that are inherent in fibers as materials are prevented from being impaired, and a high degree of flame retardancy is provided. Low-resilience urethane foam is covered with such a flame-blocking fabric, and thus a bedding product or the like can be manufactured in which softness and sensation particular to the low-resilience urethane foam as a material are prevented from being impaired, and comfort and a high degree of flame retardancy are provided. The following describes the present invention in further detail by way of examples, though the present invention is not limited to the examples.

### EXAMPLES

### Method of Preparing a Cushion for Evaluation of Flame Retardancy

As low-resilience urethane foam, low-resilience urethane foam that is used in a low-resilience urethane mattress available from Tempur World, Inc. was cut out to the size of about 25 cm in length, about 25 cm in width and about 10 cm in thickness and used. The urethane foam thus cut out was used as a stuffing inside a cushion and was covered completely with one pile knit fabric or a two-ply fabric composed of a pile knit fabric and a knit fabric, and an opening of the cushion was closed completely using a cotton yarn, and thus the cushion having the size of about 33 cm in length, about 33 cm in width, and about 10 cm in height was prepared.

### (Method of Evaluating Flame Retadancy)

Using the above-described cushion for evaluation of flame retardancy, the evaluation of the flame retardancy of a low-resilience urethane foam cushion was performed based on the draft of Technical Bulletin 604 (hereinafter, referred to as TB 604) of the state of California, U.S.A. issued in October 2003, which explains a pillow burning test method. The burning test method according to TB 604 of the state of California, U.S.A. is described briefly in the following. That is, a flame of 35 mm is allowed to reach a cushion (pillow) from a site ¾ inches below a corner of the cushion for 20 minutes, and if the rate of weight decrease after 6 minutes is not more than 20 wt %, the cushion is evaluated as passing the test. In this case, a burner tube having an inner diameter of 6.5 mm, an outer diameter of 8 mm, and a length of 200 mm is used. As a heating gas, a butane gas having a purity of not less than 99% is used, the flow rate of the butane gas is set to 45 ml/min, and the flame is set to have a height of about 35 mm.

A cushion exhibiting a rate of weight decrease at 360 seconds after being brought into contact with a flame was evaluated as passing the test. In tables that will be shown later, a cushion exhibited a rate of weight decrease within the range up to 20 wt % is indicated as “∘”, and each of other cushions is indicated as

### Manufacturing Example of the Halogen-Containing Fiber (A)

A copolymer obtained by copolymerization of 52 parts by weight of acrylonitrile, 46.8 parts by weight of vinylidene chloride, and 1.2 parts by weight of sodium styrenesulfonate was dissolved in acetone to form a 30 wt % solution. At this time, 8 parts by weight of antimony trioxide with respect to 100 parts by weight of the copolymer was added, and thus a spinning dope was prepared. The obtained spinning dope was extruded into an aqueous solution of 38 wt % acetone at 25° C. using a nozzle having a hole diameter of 0.07 mm and 33,000 holes, and a filament thus obtained was washed with water and subsequently dried at 120° C. for 8 minutes. The filament was stretched to a 3-fold length at 150° C. and heat-treated at 175° C. for 30 seconds, and thus the halogen-containing fiber (A) having a fineness of 2 dtex was obtained. A finishing oil agent for spinning (available from Takemoto Oil & Fat Co., Ltd.) was applied to the obtained halogen-containing flame-retardant fiber, and the fiber was crimped and cut to a length of 51 mm.

### Manufacturing Example of the Flame-Retardant Rayon Fiber (B)

A rayon fiber (having a fineness of 1.5 dtex and a cut length of 38 mm) was immersed in an aqueous solution of 10 wt % ammonium polyphosphate (available from Suzuhiro Chemical Co., Ltd., FCP-730) and was subjected to dehydration so that the ammonium polyphosphate adhered in an amount of 20 wt % with respect to the rayon fiber, followed by drying at 80° C., and thus a flame-retardant rayon fiber was obtained.

### (Spun Yarns 1 to 5)

Using the halogen-containing fiber (A) prepared in Manufacturing Example of the halogen-containing fiber (A), “Visil” available from Säteri Oy as the silicic acid-containing rayon fiber (B) (having a fineness of 1.7 dtex and a cut length of 40 mm), the flame-retardant rayon fiber (B) prepared in Manufacturing Example of the flame-retardant rayon fiber, the cotton fiber (C), and the polyester fiber (D) (having a fineness of 1.7 dtex and a cut length of 51 mm), spun yarns with a metric count of No. 51 were obtained by a well-known method. Spun yarns 1 to 5 are shown in Table 5.

### [Table 1]

TABLE 1
Manufacturing Examples of spun yarns

| Spun yarn No. | Fiber used |
|---|---|
| 1 | Halogen-containing fiber (A) |
| 2 | Silicic acid-containing rayon fiber (B) |
| 3 | Flame-retardant rayon fiber (B) |
| 4 | Cotton fiber (C) |
| 5 | Polyester fiber (D) |

### Manufacturing Examples 1 to 34 of Pile Knit Fabrics

Using the spun yarns 1 to 5, pile knit fabrics were prepared with a well-known sinker pile knitting machine. Next, as a finishing procedure, loops in a pile portion were cut by shirring, and thus pile knit fabrics respectively having mixing rates and weights per unit area shown in Table 2 were prepared.

### [Table 2]

TABLE 2
Manufacturing Examples of pile knit fabrics

| | | Mixing rate of fibers (wt %) | | | | | | |
|---|---|---|---|---|---|---|---|---|
| | | | | | | | Base | |
| | | Whole fabric | | | | | yarn | |
| | | | Silicic | | | | Rate | Weight |
| | Nos. of | | acid- | Flame- | | | and | per |
| Manu. Ex. No. | spun | Halogen- | contain. | retard. | | | type of | unit |
| of pile knit | yarns | contain. | rayon | rayon | Cotton | Polyester | base | area |
| fabric | used | fiber (A) | fiber (B) | fiber (B) | fiber (C) | fiber (D) | yarn | (g/m²) |
| Manu. Ex. 1 | 1, 4 | 28 | | | 72 | | | 307 |
| Manu. Ex. 2 | 1, 4, 5 | 28 | | | 45 | 27 | 27 (D) | 313 |
| Manu. Ex. 3 | 1, 4 | 68 | | | 32 | | 32 (C) | 310 |
| Manu. Ex. 4 | 1, 4, 5 | 43 | | | 32 | 25 | 25 (D) | 312 |
| Manu. Ex. 5 | 2, 4 | | 28 | | 72 | | 32 (C) | 310 |
| Manu. Ex. 6 | 3, 4 | | | 28 | 72 | | 32 (C) | 313 |
| Manu. Ex. 7 | 2, 4, 5 | | 28 | | 45 | 27 | 27 (D) | 308 |
| Manu. Ex. 8 | 2, 4 | | 68 | | 32 | | 32 (C) | 311 |
| Manu. Ex. 9 | 2, 5 | | 73 | | | 27 | 27 (D) | 312 |
| Manu. Ex. 10 | 2, 4, 5 | | 43 | | 32 | 25 | 25 (D) | 307 |
| Manu. Ex. 11 | 1, 2, 4 | 14 | 14 | | 72 | | 32 (C) | 303 |
| Manu. Ex. 12 | 1, 3, 4 | 14 | | 14 | 72 | | 32 (C) | 318 |
| Manu. Ex. 13 | 1, 2, 4, 5 | 14 | 14 | | 45 | 27 | 27 (D) | 306 |
| Manu. Ex. 14 | 1, 2, 4, 5 | 18 | 50 | | 32 | | 32 (C) | 310 |
| Manu. Ex. 15 | 1, 2, 4 | 50 | 23 | | 27 | | 32 (C) | 307 |
| Manu. Ex. 16 | 1, 2, 5 | 23 | 50 | | | 27 | 27 (D) | 310 |
| Manu. Ex. 17 | 1, 2, 5 | 50 | 23 | | | 27 | 27 (D) | 307 |
| Manu. Ex. 18 | 1, 4 | 22 | | | 78 | | 32 (C) | 305 |
| Manu. Ex. 19 | 1, 4, 5 | 22 | | | 50 | 28 | 28 (D) | 315 |
| Manu. Ex. 20 | 1, 5 | 57 | | | | 43 | 28 (D) | 308 |
| Manu. Ex. 21 | 1, 4 | 78 | | | 22 | | 22 (C) | 313 |
| Manu. Ex. 22 | 1, 5 | 78 | | | | 22 | 22 (D) | 313 |
| Manu. Ex. 23 | 2, 4 | | 22 | | 78 | | 32 (C) | 307 |
| Manu. Ex. 24 | 2, 4, 5 | | 22 | | 50 | 28 | 28 (D) | 313 |
| Manu. Ex. 25 | 2, 5 | | 57 | | | 43 | 28 (D) | 303 |
| Manu. Ex. 26 | 2, 4 | | 78 | | 22 | | 22 (C) | 310 |
| Manu. Ex. 27 | 2, 5 | | 78 | | | 22 | 22 (D) | 313 |
| Manu. Ex. 28 | 1, 2, 4 | 8 | 14 | | 78 | | 32 (C) | 316 |
| Manu. Ex. 29 | 1, 2, 4, 5 | 8 | 14 | | 50 | 28 | 28 (D) | 304 |
| Manu. Ex. 30 | 1, 2, 4 | 18 | 60 | | 22 | | 22 (C) | 311 |
| Manu. Ex. 31 | 1, 2, 4 | 60 | 18 | | 22 | | 22 (C) | 313 |
| Manu. Ex. 32 | 1, 2, 5 | 10 | 47 | | | 43 | 28 (D) | 305 |
| Manu. Ex. 33 | 1, 2, 5 | 47 | 10 | | | 43 | 28 (D) | 311 |
| Manu. Ex. 34 | 4, 5 | | | | 72 | 28 | 28 (D) | 310 |

### Manufacturing Examples 35 to 67 of Knit Fabrics

Using the spun yarns 1 to 5, knit fabrics respectively having mixing rates and weights per unit area shown in Table 3 were prepared with a well-known circular plain knitting machine.

### [Table 3]

TABLE 3
Manufacturing Examples of knit fabrics

| | | Mixing rate of fibers (wt %) | | | | | |
|---|---|---|---|---|---|---|---|
| | | | Silicic | | | | Weight |
| | Nos. of | | acid- | Flame- | | | per |
| | spun | Halogen- | contain. | retard. | | | unit |
| Manu. Ex. No. | yarns | contain. | rayon | rayon | Cotton | Polyester | area |
| of knit fabric | used | fiber (A) | fiber (B) | fiber (B) | fiber (C) | fiber (D) | (g/m²) |
| Manu. Ex. 35 | 1, 4 | 28 | | | 72 | | 127 |
| Manu. Ex. 36 | 1, 4, 5 | 28 | | | 45 | 27 | 130 |
| Manu. Ex. 37 | 1, 4 | 68 | | | 32 | | 145 |
| Manu. Ex. 38 | 1, 4, 5 | 43 | | | 32 | 25 | 142 |
| Manu. Ex. 39 | 2, 4 | | 28 | | 72 | | 130 |
| Manu. Ex. 40 | 3, 4 | | | 28 | 72 | | 130 |
| Manu. Ex. 41 | 2, 4, 5 | | 28 | | 45 | 27 | 138 |
| Manu. Ex. 42 | 2, 4 | | 68 | | 32 | | 145 |
| Manu. Ex. 43 | 2, 5 | | 73 | | | 27 | 140 |
| Manu. Ex. 44 | 2, 4, 5 | | 43 | | 32 | 25 | 142 |
| Manu. Ex. 45 | 1, 2, 4 | 14 | 14 | | 72 | | 142 |
| Manu. Ex. 46 | 1, 3, 4 | 14 | | 14 | 72 | | 145 |
| Manu. Ex. 47 | 1, 2, 4, 5 | 14 | 14 | | 45 | 27 | 142 |
| Manu. Ex. 48 | 1, 2, 4, 5 | 18 | 50 | | 32 | | 135 |
| Manu. Ex. 49 | 1, 2, 4 | 50 | 23 | | 27 | | 133 |
| Manu. Ex. 50 | 1, 2, 5 | 23 | 50 | | | 27 | 142 |
| Manu. Ex. 51 | 1, 2, 5 | 50 | 23 | | | 27 | 139 |
| Manu. Ex. 52 | 1, 4 | 22 | | | 78 | | 130 |
| Manu. Ex. 53 | 1, 4, 5 | 22 | | | 50 | 28 | 125 |
| Manu. Ex. 54 | 1, 5 | 57 | | | | 43 | 143 |
| Manu. Ex. 55 | 1, 4 | 78 | | | 22 | | 135 |
| Manu. Ex. 56 | 1, 5 | 78 | | | | 22 | 135 |
| Manu. Ex. 57 | 2, 4 | | 22 | | 78 | | 141 |
| Manu. Ex. 58 | 2, 4, 5 | | 22 | | 50 | 28 | 138 |
| Manu. Ex. 59 | 2, 5 | | 57 | | | 43 | 144 |
| Manu. Ex. 60 | 2, 4 | | 78 | | 22 | | 142 |
| Manu. Ex. 61 | 2, 5 | | 78 | | | 22 | 135 |
| Manu. Ex. 62 | 1, 2, 4 | 8 | 14 | | 78 | | 129 |
| Manu. Ex. 63 | 1, 2, 4, 5 | 8 | 14 | | 50 | 28 | 135 |
| Manu. Ex. 64 | 1, 2, 4 | 18 | 60 | | 22 | | 145 |
| Manu. Ex. 65 | 1, 2, 4 | 60 | 18 | | 22 | | 147 |
| Manu. Ex. 66 | 1, 2, 5 | 10 | 47 | | | 43 | 130 |
| Manu. Ex. 67 | 1, 2, 5 | 47 | 10 | | | 43 | 142 |

### Examples 1 to 4, Comparative Examples 1 to 5

Using the pile knit fabrics prepared in Manufacturing Examples 1 to 4 and Manufacturing Examples 18 to 22, cushions for evaluation of flame retardancy were prepared. Table 4 shows the results of the evaluation of flame retardancy.

In each of Examples 1 to 4, excellent flame retardancy and an excellent state of a carbonized film were observed in the burning test. In each of Comparative Examples 1 and 2, due to the low content of the halogen-containing fiber, the fabric exhibited insufficient extinguishing capability. In Comparative Example 3, due to the high content of the polyester fiber, the ratio of a burnable component in the flame-blocking fabric became high to deteriorate the flame-blocking property of the fabric. In Comparative Example 4, while the halogen-containing fiber was contained in a sufficient amount to achieve excellent flame retardancy, the ratio of the cotton fiber was low, thus rendering the fabric unsatisfactory in texture and comfort in terms of touch feeling, hygroscopicity or the like. Comparative Example 5 was an example in which the cotton fiber used in Comparative Example 4 was replaced by the polyester fiber and exhibited deterioration of hygroscopicity in addition to the disadvantages exhibited in Comparative Example 4.

### [Table 4]

TABLE 4
Flame-blocking pile knit fabrics

| | | | | | | | Structure of | | | | | |
|---|---|---|---|---|---|---|---|---|---|---|---|---|
| | | | | | | | ticking•flame-blocking fabric | | | | | |
| | | Mixing ratio in flame-blocking fabric (wt %) | | | | | | Weight | | Burning test | | |
| | Manu. | | Silicic | | | | Amount | per unit | | Weight | | |
| | Ex. No. | | acid- | Flame- | | | of flame | area of | Thickness | decrease | Weight | |
| | of pile | Halogen- | contain. | retard. | | | retardant | pile knit | of pile | rate after | decrease | |
| Ex. | knit | contain. | rayon | cellulosic | Cotton | Polyester | in fabric | fabric | knit fabric | 6 min. | finishing | |
| No. | fabric | fiber (A) | fiber (B) | fiber (B) | fiber (C) | fiber (D) | (wt %) | (g/m²) | (mm) | (%) | time (sec.) | Judgment |
| Ex. 1 | 1 | 28 | 0 | 0 | 72 | 0 | 2.1 | 307 | 1.4 | 3.1 | >1800 | ∘ |
| Ex. 2 | 2 | 28 | 0 | 0 | 45 | 27 | 2.1 | 313 | 1.4 | 3.9 | 1650 | ∘ |
| Ex. 3 | 3 | 68 | 0 | 0 | 32 | 0 | 5.3 | 310 | 1.2 | 4.4 | 1560 | ∘ |
| Ex. 4 | 4 | 43 | 0 | 0 | 32 | 25 | 3.2 | 312 | 1.3 | 4.9 | 1600 | ∘ |
| Com. | 18 | 22 | 0 | 0 | 78 | 0 | 1.6 | 305 | 1.3 | 20.9 | Forcefully | x |
| Ex. 1 | | | | | | | | | | | extinguished | |
| Com. | 19 | 22 | 0 | 0 | 50 | 28 | 1.6 | 315 | 1.4 | 22.4 | Forcefully | x |
| Ex. 2 | | | | | | | | | | | extinguished | |
| Com. | 20 | 57 | 0 | 0 | 0 | 43 | 4.2 | 308 | 1.2 | 24.5 | Forcefully | x |
| Ex. 3 | | | | | | | | | | | extinguished | |
| Com. | 21 | 78 | 0 | 0 | 22 | 0 | 5.8 | 313 | 1.2 | 3.2 | 950 | ∘ |
| Ex. 4 | | | | | | | | | | | | |
| Com. | 22 | 78 | 0 | 0 | 0 | 22 | 5.8 | 313 | 1.1 | 5.1 | 1030 | ∘ |
| Ex. 5 | | | | | | | | | | | | |

### Example 5 to 10, Comparative Examples 6 to 10

Using the pile knit fabrics prepared in Manufacturing Examples 5 to 10 and Manufacturing Examples 23 to 27, cushions for evaluation of flame retardancy were prepared. Table 5 shows the results of the evaluation of flame retardancy.

In each of Examples 5 to 10, excellent flame retardancy and an excellent state of a carbonized film were observed in the burning test. In each of Comparative Examples 6 and 7, due to the low content of the silicic acid-containing cellulosic fiber, the fabric exhibited insufficient extinguishing capability. In Comparative Example 8, due to the high content of the polyester fiber, the ratio of a burnable component in the flame-blocking fabric became high to deteriorate the flame-blocking property of the fabric. In Comparative Example 9, while the silicic acid-containing rayon fiber was contained in a sufficient amount to achieve excellent flame retardancy, the ratio of the silicic-acid containing rayon fiber was too high to achieve the texture required of bedding products and good touch feeling, and the fabric also exhibited such poor workability that spinning and knitting processings hardly could be performed. Comparative Example 10 was an example in which the cotton fiber used in Comparative Example 9 was replaced by the polyester fiber and exhibited deterioration of hygroscopicity in addition to the disadvantages exhibited in Comparative Example 9.

### [Table 5]

TABLE 5
Flame-blocking pile knit fabrics

| | | | | | | | Structure of | | | | | |
|---|---|---|---|---|---|---|---|---|---|---|---|---|
| | | | | | | | ticking•flame-blocking fabric | | | | | |
| | | Mixing ratio in flame-blocking fabric (wt %) | | | | | | Weight | | Burning test | | |
| | Manu. | | Silicic | | | | Amount | per unit | | Weight | | |
| | Ex. No. | | acid- | Flame- | | | of flame | area of | Thickness | decrease | Weight | |
| | of pile | Halogen- | contain. | retard. | | | retardant | pile knit | of pile | rate after | decrease | |
| Ex. | knit | contain. | rayon | cellulosic | Cotton | Polyester | in fabric | fabric | knit fabric | 6 min. | finishing | |
| No. | fabric | fiber (A) | fiber (B) | fiber (B) | fiber (C) | fiber (D) | (wt %) | (g/m²) | (mm) | (%) | time (sec.) | Judgment |
| Ex. 5 | 5 | 0 | 28 | 0 | 72 | 0 | 8.4 | 310 | 1.4 | 13.2 | >1800 | ∘ |
| Ex. 6 | 6 | 0 | 0 | 28 | 72 | 0 | 4.7 | 313 | 1.4 | 7.8 | 1590 | ∘ |
| Ex. 7 | 7 | 0 | 28 | 0 | 45 | 27 | 8.4 | 308 | 1.3 | 15.6 | >1800 | ∘ |
| Ex. 8 | 8 | 0 | 68 | 0 | 32 | 0 | 20.4 | 311 | 1.2 | 8.3 | >1800 | ∘ |
| Ex. 9 | 9 | 0 | 73 | 0 | 0 | 27 | 21.9 | 312 | 1.2 | 8.2 | >1800 | ∘ |
| Ex. 10 | 10 | 0 | 43 | 0 | 32 | 25 | 12.9 | 307 | 1.2 | 10.9 | >1800 | ∘ |
| Com. | 23 | 0 | 22 | 0 | 78 | 0 | 6.6 | 307 | 1.3 | 22.9 | Forcefully | x |
| Ex. 6 | | | | | | | | | | | extinguished | |
| Com. | 24 | 0 | 22 | 0 | 50 | 28 | 6.6 | 313 | 1.4 | 24.6 | Forcefully | x |
| Ex. 7 | | | | | | | | | | | extinguished | |
| Com. | 25 | 0 | 57 | 0 | 0 | 43 | 17.1 | 303 | 1.2 | 23.3 | Forcefully | x |
| Ex. 8 | | | | | | | | | | | extinguished | |
| Com. | 26 | 0 | 78 | 0 | 22 | 0 | 23.4 | 310 | 1.2 | 7.9 | >1800 | ∘ |
| Ex. 9 | | | | | | | | | | | | |
| Com. | 27 | 0 | 78 | 0 | 0 | 22 | 23.4 | 313 | 1.1 | 7.9 | >1800 | ∘ |
| Ex. 10 | | | | | | | | | | | | |

### Examples 11 to 17, Comparative Examples 11 to 16

Using the pile knit fabrics prepared in Manufacturing Examples 11 to 17 and 28 to 33, cushions for evaluation of flame retardancy were prepared. Table 6 shows the results of the evaluation of flame retardancy.

In each of Examples 11 to 17, excellent flame retardancy and an excellent state of a carbonized film were observed in the burning test. In each of Comparative Examples 11 and 12, due to the low content of the halogen-containing fiber and the silicic acid-containing cellulosic fiber in total, the fabric exhibited insufficient extinguishing capability. In Comparative Example 13, while the ratio of the halogen-containing fiber and the silicic acid-containing cellulosic fiber in total was sufficiently high to achieve excellent flame retardancy, the ratio of the flame-retardant fibers to the fabric was too high to achieve the texture required of bedding products and good touch feeling. Similarly to Comparative Example 13, also in Comparative Example 14, while the ratio of the halogen-containing fiber and the silicic acid-containing cellulosic fiber in total was sufficiently high to achieve excellent flame retardancy, the ratio of the flame-retardant fibers to the fabric was high, thus rendering the fabric insufficient in texture required of bedding products as well as in touch feeling, and the content of a cellulosic component was low even compared with that in Comparative Example 13, so that the touch feeling and texture of the cellolosic fiber seemed less perceptible. In each of Comparative Examples 15 and 16, due to the high content of the polyester fiber, the ratio of a burnable component in the flame-blocking fabric became high to deteriorate the flame-blocking property of the fabric.

### [Table 6]

TABLE 6
Flame-blocking pile knit fabrics

| | | | | | | | Structure of | | | | | |
|---|---|---|---|---|---|---|---|---|---|---|---|---|
| | | | | | | | ticking•flame-blocking fabric | | | | | |
| | | Mixing ratio in flame-blocking fabric (wt %) | | | | | | Weight | | Burning test | | |
| | Manu. | | Silicic | | | | Amount | per unit | | Weight | | |
| | Ex. No. | | acid- | Flame- | | | of flame | area of | Thickness | decrease | Weight | |
| | of pile | Halogen- | contain. | retard. | | | retardant | pile knit | of pile | rate after | decrease | |
| Ex. | knit | contain. | rayon | cellulosic | Cotton | Polyester | in fabric | fabric | knit fabric | 6 min. | finishing | |
| No. | fabric | fiber (A) | fiber (B) | fiber (B) | fiber (C) | fiber (D) | (wt %) | (g/m²) | (mm) | (%) | time (sec.) | Judgment |
| Ex. 11 | 11 | 14 | 14 | 0 | 72 | 0 | 5.2 | 303 | 1.4 | 3.9 | 1610 | ∘ |
| Ex. 12 | 12 | 14 | 0 | 14 | 72 | 0 | 3.4 | 318 | 1.4 | 2.5 | 1010 | ∘ |
| Ex. 13 | 13 | 14 | 14 | 0 | 45 | 27 | 5.2 | 306 | 1.4 | 5.3 | >1800 | ∘ |
| Ex. 14 | 14 | 18 | 50 | 0 | 32 | 0 | 16.3 | 310 | 1.2 | 6.2 | 1540 | ∘ |
| Ex. 15 | 15 | 50 | 23 | 0 | 27 | 0 | 10.6 | 307 | 1.3 | 4.0 | 1280 | ∘ |
| Ex. 16 | 16 | 23 | 50 | 0 | 0 | 27 | 16.7 | 310 | 1.3 | 4.0 | 1720 | ∘ |
| Ex. 17 | 17 | 50 | 23 | 0 | 0 | 27 | 10.6 | 307 | 1.2 | 4.9 | 1400 | ∘ |
| Com. | 28 | 8 | 14 | 0 | 78 | 0 | 4.8 | 316 | 1.3 | 22.1 | Forcefully | x |
| Ex. 11 | | | | | | | | | | | extinguished | |
| Com. | 29 | 8 | 14 | 0 | 50 | 28 | 4.8 | 304 | 1.4 | 21.9 | Forcefully | x |
| Ex. 12 | | | | | | | | | | | extinguished | |
| Com. | 30 | 18 | 60 | 0 | 22 | 0 | 19.3 | 311 | 1.3 | 10.0 | >1800 | ∘ |
| Ex. 13 | | | | | | | | | | | | |
| Com. | 31 | 60 | 18 | 0 | 22 | 0 | 9.8 | 313 | 1.2 | 6.8 | >1800 | ∘ |
| Ex. 14 | | | | | | | | | | | | |
| Com. | 32 | 10 | 47 | 0 | 0 | 43 | 14.8 | 305 | 1.3 | 21.4 | Forcefully | x |
| Ex. 15 | | | | | | | | | | | extinguished | |
| Com. | 33 | 47 | 10 | 0 | 0 | 43 | 6.5 | 311 | 1.2 | 21.9 | Forcefully | x |
| Ex. 16 | | | | | | | | | | | extinguished | |

### Examples 18 to 21

Using the non-flame-retardant pile knit fabric prepared in Manufacturing Example 34 as an outer ticking, each of knit fabrics that were the flame-blocking fabrics prepared in Manufacturing Examples 35 to 38 was sandwiched between the ticking and low-resilience urethane foam, and thus cushions for evaluation of flame retardancy were prepared. Table 7 shows the results of the evaluation of flame retardancy.

### Comparative Examples 17 to 20

Using the knit fabrics prepared in Manufacturing Examples 35 to 38, cushions for evaluation of flame retaradancy were prepared. Table 7 shows the results of the evaluation of flame retardancy.

### Comparative Examples 21 to 25

Using the pile knit fabric prepared in Manufacturing Example 34 and the knit fabrics prepared in Manufacturing Examples 52 to 56, cushions for evaluation of flame retardancy were prepared, and Table 7 shows the results of the evaluation of flame retardancy.

In each of Examples 18 to 21, excellent flame retardancy and an excellent state of a carbonized film were observed in the burning test. In Comparative Examples 17 to 20, though the same fiber structures as in Examples 18 to 21 were used, respectively, each fabric had an insufficient thickness and thus exhibited insufficient flame retardancy. In each of Comparative Examples 21 and 22, due to the low content of the halogen-containing fiber, the fabric exhibited insufficient extinguishing capability. In Comparative Example 23, due to the high content of the polyester fiber, the ratio of a burnable component in the flame-blocking fabric became high to deteriorate the flame-blocking property of the fabric. In Comparative Example 24, while the halogen-containing fiber was contained in a sufficient amount to achieve excellent flame retardancy, the ratio of the cotton fiber was low, thus rendering the fabric unsatisfactory in texture and comfort in terms of touch feeling, hygroscopicity or the like. Comparative Example 25 was an example in which the cotton fiber used in Comparative Example 24 was replaced by the polyester fiber and exhibited deterioration of hygroscopicity in addition to the disadvantages exhibited in Comparative Example 24.

### [Table 7]

TABLE 7
Flame-blocking knit fabrics

| | | | | | | | Structure of | | | | | |
|---|---|---|---|---|---|---|---|---|---|---|---|---|
| | | | | | | | ticking•flame-blocking fabric | | | | | |
| | | Mixing ratio in flame-blocking fabric (wt %) | | | | | Amount of | Weight | | Burning test | | |
| | | | Silicic | | | | flame | per unit | | Weight | | |
| | Manu. Ex. | | acid- | Flame- | | Poly- | retardant | area of | Thickness | decrease | Weight | |
| | No. of | Halogen- | contain. | retard. | Cotton | ester | in knit | ticking | of ticking | rate | decrease | |
| | fabric | contain. | rayon | cellulosic | fiber | fiber | fabric | (pile/knit) | (pile/knit) | after 6 min. | finishing | |
| Ex. No. | (pile/knit) | fiber (A) | fiber (B) | fiber (B) | (C) | (D) | (wt %) | (g/m²) | (mm) | (%) | time (sec.) | Judgment |
| Ex. 18 | 34/35 | 28 | 0 | 0 | 72 | 0 | 2.1 | 310/127 | 1.4/0.6 | 5.7 | 1230 | ∘ |
| Ex. 19 | 34/36 | 28 | 0 | 0 | 45 | 27 | 2.1 | 310/130 | 1.4/0.6 | 4.5 | 930 | ∘ |
| Ex. 20 | 34/37 | 68 | 0 | 0 | 32 | 0 | 5.3 | 310/145 | 1.4/0.7 | 2.7 | 150 | ∘ |
| Ex. 21 | 34/38 | 43 | 0 | 0 | 32 | 25 | 3.2 | 310/142 | 1.4/0.7 | 10.3 | >1800 | ∘ |
| Com. | None/35 | 28 | 0 | 0 | 72 | 0 | 2.1 | None/127 | None/0.6 | 23.4 | Forcefully | x |
| Ex. 17 | | | | | | | | | | | extinguished | |
| Com. | None/36 | 28 | 0 | 0 | 45 | 27 | 2.1 | None/130 | None/0.6 | 20.8 | Forcefully | x |
| Ex. 18 | | | | | | | | | | | extinguished | |
| Com. | None/37 | 68 | 0 | 0 | 32 | 0 | 5.3 | None/145 | None/0.7 | 20.5 | Forcefully | x |
| Ex. 19 | | | | | | | | | | | extinguished | |
| Com. | None/38 | 43 | 0 | 0 | 32 | 25 | 3.2 | None/142 | None/0.7 | 26.0 | Forcefully | x |
| Ex. 20 | | | | | | | | | | | extinguished | |
| Com. | 34/52 | 22 | 0 | 0 | 78 | 0 | 1.6 | 310/130 | 1.4/0.6 | 21.0 | Forcefully | x |
| Ex. 21 | | | | | | | | | | | extinguished | |
| Com. | 34/53 | 22 | 0 | 0 | 50 | 28 | 1.6 | 310/125 | 1.4/0.6 | 22.4 | Forcefully | x |
| Ex. 22 | | | | | | | | | | | extinguished | |
| Com. | 34/54 | 57 | 0 | 0 | 0 | 43 | 4.2 | 310/143 | 1.4/0.7 | 20.5 | Forcefully | x |
| Ex. 23 | | | | | | | | | | | extinguished | |
| Com. | 34/55 | 78 | 0 | 0 | 22 | 0 | 5.8 | 310/135 | 1.4/0.6 | 6.4 | 1760 | ∘ |
| Ex. 24 | | | | | | | | | | | | |
| Com. | 34/56 | 78 | 0 | 0 | 0 | 22 | 5.8 | 310/135 | 1.4/0.6 | 8.8 | >1800 | ∘ |
| Ex. 25 | | | | | | | | | | | | |

### Examples 22 to 27

Using the pile knit fabric prepared in Manufacturing Example 34 and the knit fabrics prepared in Manufacturing Examples 39 to 44, cushions for evaluation of flame retardancy were prepared. Table 8 shows the results of the evaluation of flame retardancy.

### Comparative Examples 26 to 31

Using the knit fabrics prepared in Manufacturing Examples 39 to 44, cushions for evaluation of flame retaradancy were prepared. Table 8 shows the results of the evaluation of flame retardancy.

### Comparative Examples 32 to 36

Using the pile knit fabric prepared in Manufacturing Example 34 and the knit fabrics prepared in Manufacturing Examples 57 to 61, cushions for evaluation of flame retardancy were prepared. Table 8 shows the results of the evaluation of flame retardancy.

In each of Examples 22 to 27, excellent flame retardancy and an excellent state of a carbonized film were observed in the burning test. In Comparative Examples 26 to 31, though the same fiber structures as in Examples 22 to 27 were used, respectively, each fabric had an insufficient thickness and thus exhibited insufficient flame retardancy. In each of Comparative Examples 32 and 33, due to the low content of the silicic acid-containing cellulosic fiber, the fabric exhibited insufficient extinguishing capability. In Comparative Example 34, due to the high content of the polyester fiber, the ratio of a burnable component in the flame-blocking fabric became high to deteriorate the flame-blocking property of the fabric. In Comparative Example 35, while the silicic acid-containing rayon fiber was contained in a sufficient amount to achieve excellent flame retardancy, the ratio of the silicic-acid containing rayon fiber was too high to achieve the texture required of bedding products and good touch feeling, and the fabric also exhibited such poor workability that spinning and knitting processings hardly could be performed. Comparative Example 36 was an example in which the cotton fiber used in Comparative Example 35 was replaced by the polyester fiber and exhibited deterioration of hygroscopicity in addition to the disadvantages exhibited in Comparative Example 35.

### [Table 8]

TABLE 8
Flame-blocking knit fabrics

| | | | | | | | Structure of | | | | | |
|---|---|---|---|---|---|---|---|---|---|---|---|---|
| | | | | | | | ticking•flame-blocking fabric | | | | | |
| | | | | | | | | Weight per unit | Thickness of | | | |
| | | Mixing ratio in flame-blocking fabric (wt %) | | | | | Amount of | area of outer | pile knit | Burning test | | |
| | Manu. Ex. | | Silicic acid- | Flame- | Cot- | Poly- | flame | ticking/weight | fabric/ | Weight | Weight | |
| | No. of | Halogen- | contain. | retard. | ton | ester | retardant | per unit area of | thickness of | decrease | decrease | |
| | fabric | contain. | rayon fiber | cellulosic | fiber | fiber | in fabric | knit fabric | knit fabric | rate after | finishing | Judg- |
| Ex. No. | (pile/knit) | fiber (A) | (B) | fiber (B) | (C) | (D) | (wt %) | (g/m²) | (mm) | 6 min. (%) | time (sec.) | ment |
| Ex. 22 | 34/39 | 0 | 28 | 0 | 72 | 0 | 8.4 | 310/130 | 1.4/0.6 | 11.6 | >1800 | ∘ |
| Ex. 23 | 34/40 | 0 | 0 | 28 | 72 | 0 | 4.7 | 310/130 | 1.4/0.6 | 4.5 | 930 | ∘ |
| Ex. 24 | 34/41 | 0 | 28 | 0 | 45 | 27 | 8.4 | 310/138 | 1.4/0.6 | 13.5 | >1800 | ∘ |
| Ex. 25 | 34/42 | 0 | 68 | 0 | 32 | 0 | 20.4 | 310/145 | 1.4/0.7 | 9.2 | >1800 | ∘ |
| Ex. 26 | 34/43 | 0 | 73 | 0 | 0 | 27 | 21.9 | 310/140 | 1.4/0.7 | 7.2 | 1780 | ∘ |
| Ex. 27 | 34/44 | 0 | 43 | 0 | 32 | 25 | 12.9 | 310/142 | 1.4/0.7 | 6.2 | >1800 | ∘ |
| Com. | None/39 | 0 | 28 | 0 | 72 | 0 | 8.4 | None/130 | None/0.6 | 27.3 | Forcefully | x |
| Ex. 26 | | | | | | | | | | | extinguished | |
| Com. | None/40 | 0 | 0 | 28 | 72 | 0 | 4.7 | None/130 | None/0.6 | 20.5 | Forcefully | x |
| Ex. 27 | | | | | | | | | | | extinguished | |
| Com. | None/41 | 0 | 28 | 0 | 45 | 27 | 8.4 | None/138 | None/0.6 | 28.9 | Forcefully | x |
| Ex. 28 | | | | | | | | | | | extinguished | |
| Com. | None/42 | 0 | 68 | 0 | 32 | 0 | 20.4 | None/145 | None/0.7 | 26.4 | Forcefully | x |
| Ex. 29 | | | | | | | | | | | extinguished | |
| Com. | None/43 | 0 | 73 | 0 | 0 | 27 | 21.9 | None/140 | None/0.7 | 22.6 | Forcefully | x |
| Ex. 30 | | | | | | | | | | | extinguished | |
| Com. | None/44 | 0 | 43 | 0 | 32 | 25 | 12.9 | None/142 | None/0.7 | 21.8 | Forcefully | x |
| Ex. 31 | | | | | | | | | | | extinguished | |
| Com. | 34/57 | 0 | 22 | 0 | 78 | 0 | 6.6 | 310/141 | 1.4/0.7 | 21.5 | Forcefully | x |
| Ex. 32 | | | | | | | | | | | extinguished | |
| Com. | 34/58 | 0 | 22 | 0 | 50 | 28 | 6.6 | 310/138 | 1.4/0.6 | 22.4 | Forcefully | x |
| Ex. 33 | | | | | | | | | | | extinguished | |
| Com. | 34/59 | 0 | 57 | 0 | 0 | 43 | 17.1 | 310/144 | 1.4/0.7 | 21.8 | Forcefully | x |
| Ex. 34 | | | | | | | | | | | extinguished | |
| Com. | 34/60 | 0 | 78 | 0 | 22 | 0 | 23.4 | 310/142 | 1.4/0.7 | 6.6 | 1540 | ∘ |
| Ex. 35 | | | | | | | | | | | | |
| Com. | 34/61 | 0 | 78 | 0 | 0 | 22 | 23.4 | 310/135 | 1.4/0.7 | 7.6 | 1740 | ∘ |
| Ex. 36 | | | | | | | | | | | | |

### Examples 28 to 34

Using the pile knit fabric prepared in Manufacturing Example 34 and the knit fabrics prepared in Manufacturing Examples 45 to 51, cushions for evaluation of flame retardancy were prepared. Table 9 shows the results of the evaluation of flame retardancy.

### Comparative Examples 37 to 43

Using the pile knit fabrics prepared in Manufacturing Examples 45 to 51, cushions for evaluation of flame retardancy were prepared. Table 9 shows the results of the evaluation of flame retardancy.

### Comparative Examples 44 to 49

Using the pile knit fabric prepared in Manufacturing Example 34 and the knit fabrics prepared in Manufacturing Examples 62 to 67, cushions for evaluation of flame retardancy were prepared. Table 9 shows the results of the evaluation of flame retardancy.

In each of Examples 28 to 34, excellent flame retardancy and an excellent state of a carbonized film were observed in the burning test. In Comparative Examples 37 to 43, though the same fiber structures as in Examples 28 to 34 were used, respectively, each fabric had an insufficient thickness and thus exhibited insufficient flame retardancy. In each of Comparative Examples 44 and 45, due to the low content of the halogen-containing fiber and the silicic acid-containing cellulosic fiber in total, the fabric exhibited insufficient extinguishing capability. In Comparative Example 46, while the ratio of the halogen-containing fiber and the silicic acid-containing cellulosic fiber in total was sufficiently high to achieve excellent flame retardancy, the ratio of the flame-retardant fibers to the fabric was too high to achieve the texture required of bedding products and good touch feeling. Similarly to Comparative Example 46, also in Comparative Example 47, while the ratio of the halogen-containing fiber and the silicic acid-containing cellulosic fiber in total was sufficiently high to achieve excellent flame retardancy, the ratio of the flame-retardant fibers to the fabric was high, thus rendering the fabric insufficient in texture required of bedding products as well as in touch feeling, and the content of a cellulosic component was low even compared with that in Comparative Example 46, so that the touch feeling and texture of the cellolosic fiber seemed less perceptible. In each of Comparative Examples 48 and 49, due to the high content of the polyester fiber, the ratio of a burnable component in the flame-blocking fabric became high to deteriorate the flame blocking property of the fabric.

### [Table 9]

TABLE 9
Flame-blocking knit fabrics

| | | | | | | | Structure of | | | | | |
|---|---|---|---|---|---|---|---|---|---|---|---|---|
| | | | | | | | ticking•flame-blocking fabric | | | | | |
| | | | | | | | | Weight per | | | | |
| | | | | | | | Amount | unit area | Thickness | | | |
| | | | | | | | of | of outer | of | Burning test | | |
| | | Mixing ratio in flame-blocking fabric (wt %) | | | | | flame | ticking/ | pile knit | | Weight | |
| | Manu. Ex. | | Silicic acid- | Flame- | Cot- | Poly- | retardant | weight per | fabric/ | Weight | decrease | |
| | No. of | Halogen- | contain. | retard. | ton | ester | in | unit area of | thickness of | decrease | finishing | |
| | fabric | contain. | rayon fiber | cellulosic | fiber | fiber | fabric | knit fabric | knit fabric | rate after 6 | time | Judg- |
| Ex. No. | (pile/knit) | fiber (A) | (B) | fiber (B) | (C) | (D) | (wt %) | (g/m²) | (mm) | min. (%) | (sec.) | ment |
| Ex. 28 | 34/45 | 14 | 14 | 0 | 72 | 0 | 5.2 | 310/142 | 1.4/0.7 | 5.7 | 1180 | ∘ |
| Ex. 29 | 34/46 | 14 | 0 | 14 | 72 | 0 | 3.4 | 310/145 | 1.4/0.7 | 4.0 | 990 | ∘ |
| Ex. 30 | 34/47 | 14 | 14 | 0 | 45 | 27 | 5.2 | 310/142 | 1.4/0.7 | 7.5 | >1800 | ∘ |
| Ex. 31 | 34/48 | 18 | 50 | 0 | 32 | 0 | 16.3 | 310/135 | 1.4/0.6 | 9.1 | >1800 | ∘ |
| Ex. 32 | 34/49 | 50 | 23 | 0 | 27 | 0 | 10.6 | 310/133 | 1.4/0.6 | 6.4 | 1750 | ∘ |
| Ex. 33 | 34/50 | 23 | 50 | 0 | 0 | 27 | 16.7 | 310/142 | 1.4/0.7 | 6.0 | 1680 | ∘ |
| Ex. 34 | 34/51 | 50 | 23 | 0 | 0 | 27 | 10.6 | 310/139 | 1.4/0/6 | 7.2 | 1710 | ∘ |
| Com. Ex. | None/45 | 14 | 14 | 0 | 72 | 0 | 5.2 | None/142 | None/0.7 | 24.2 | Forcefully | x |
| 37 | | | | | | | | | | | extinguished | |
| Com. Ex. | None/46 | 14 | 0 | 14 | 72 | 0 | 3.4 | None/145 | None/0.7 | 21.9 | Forcefully | x |
| 38 | | | | | | | | | | | extinguished | |
| Com. Ex. | None/47 | 14 | 14 | 0 | 45 | 27 | 5.2 | None/142 | None/0.7 | 22.4 | Forcefully | x |
| 39 | | | | | | | | | | | extinguished | |
| Com. | None/48 | 18 | 50 | 0 | 32 | 0 | 16.3 | None/135 | None/0.6 | 23.8 | Forcefully | x |
| Ex. 40 | | | | | | | | | | | extinguished | |
| Com. | None/49 | 50 | 23 | 0 | 27 | 0 | 10.6 | None/133 | None/0.6 | 23.1 | Forcefully | x |
| Ex. 41 | | | | | | | | | | | extinguished | |
| Com. Ex. | None/50 | 23 | 50 | 0 | 0 | 27 | 16.7 | None/142 | None/0.7 | 24.2 | Forcefully | x |
| 42 | | | | | | | | | | | extinguished | |
| Com. Ex. | None/51 | 50 | 23 | 0 | 0 | 27 | 10.6 | None/139 | None/0.6 | 22.8 | Forcefully | x |
| 43 | | | | | | | | | | | extinguished | |
| Com. Ex. | 34/62 | 8 | 14 | 0 | 78 | 0 | 4.8 | 310/129 | 1.4/0.6 | 21.0 | Forcefully | x |
| 44 | | | | | | | | | | | extinguished | |
| Com. Ex. | 34/63 | 8 | 14 | 0 | 50 | 28 | 4.8 | 310/135 | 1.4/0.6 | 21.5 | Forcefully | x |
| 45 | | | | | | | | | | | extinguished | |
| Com. Ex. | 34/64 | 18 | 60 | 0 | 22 | 0 | 19.3 | 310/145 | 1.4/0.7 | 7.2 | 1120 | ∘ |
| 46 | | | | | | | | | | | | |
| Com. Ex. | 34/65 | 60 | 18 | 0 | 22 | 0 | 9.8 | 310/147 | 1.4/0.8 | 5.9 | 720 | ∘ |
| 47 | | | | | | | | | | | | |
| Com. Ex. | 34/66 | 10 | 47 | 0 | 0 | 43 | 14.8 | 310/130 | 1.4/0.6 | 20.3 | Forcefully | x |
| 48 | | | | | | | | | | | extinguished | |
| Com. Ex. | 34/67 | 47 | 10 | 0 | 0 | 43 | 6.5 | 310/142 | 1.4/0.7 | 21.8 | Forcefully | x |
| 49 | | | | | | | | | | | extinguished | |

### INDUSTRIAL APPLICABILITY

In the low-resilience urethane foam cushion according to the present invention, excellent texture and touch feeling, hygroscopicity, durability and the like that are inherent in fibers as materials are prevented from being impaired, the softness and sensation particular to internally provided low-resilience urethane foam as a material are retained, and a high degree of flame retardancy is provided. Thus, the low-resilience urethane foam cushion according to the present invention can be used as a bedding product or an interior product.

1-14. (canceled)

15. A flame-retardant low-resilience urethane foam cushion in which low-resilience urethane foam is covered with a flame-blocking fabric that is formed by using at least two types of fibers selected from the group consisting of a halogen-containing fiber (A), a flame-retardant cellulosic fiber (B), a cellulosic fiber (C), and a polyester fiber (D),
wherein a total amount of the halogen-containing fiber (A) and the flame-retardant cellulosic fiber (B) is 25 to 75 wt % with respect to the flame-blocking fabric,
a total amount of the flame-retardant cellulosic fiber (B) and the cellulosic fiber (C) is not less than 30 wt % with respect to the flame-blocking fabric,
an amount of the cellulosic fiber (C) alone is not more than 75 wt % with respect to the flame-blocking fabric,
an amount of the polyester fiber (D) alone is not more than 30 wt % with respect to the flame-blocking fabric, and
a total of a thickness of the flame-blocking fabric and a thickness of a ticking that is used on an outer side of the flame-blocking fabric as required is not less than 1 mm.

16. The flame-retardant low-resilience urethane foam cushion according to claim 15, wherein the halogen-containing fiber (A) is a modacrylic fiber.

17. The flame-retardant low-resilience urethane foam cushion according to claim 15, wherein the flame-retardant cellulosic fiber (B) is a fiber that is formed of at least one fiber selected from the group consisting of cotton, hemp, rayon, polynosic, cupra, acetate, and triacetate and contains a flame retardant.

18. The flame-retardant low-resilience urethane foam cushion according to claim 15, wherein the flame-retardant cellulosic fiber (B) is a rayon fiber in which a flame retardant selected from silicic acid and aluminum silicate is contained in an amount of 20 to 50 wt %.

19. The flame-retardant low-resilience urethane foam cushion according to claim 17, wherein the flame-retardant cellulosic fiber (B) is a fiber that is formed of a cellulosic fiber to which a flame retardant selected from the group consisting of phosphoric ester compounds, halogen-containing phosphoric ester compounds, condensed phosphoric ester compounds, polyphosphate compounds, red phosphorus, amine compounds, boric acid, halogen compounds, bromides, urea-formaldehyde compounds, and ammonium sulfate adheres in an amount of 6 to 25 wt % with respect to the cellulosic fiber.

20. The flame-retardant low-resilience urethane foam cushion according to claim 15, wherein the cellulosic fiber (C) is at least one fiber selected from the group consisting of cotton, hemp, rayon, polynosic, cupra, acetate, and triacetate.

21. The flame-retardant low-resilience urethane foam cushion according to claim 20, wherein the cellulosic fiber (C) is cotton.

22. The flame-retardant low-resilience urethane foam cushion according to claim 15, wherein the polyester fiber (D) has a melting point of 200° C. or higher.

23. The flame-retardant low-resilience urethane foam cushion according to claim 15, wherein the flame-blocking fabric contains a flame retardant in an amount of 2 to 40 wt %.

24. The flame-retardant low-resilience urethane foam cushion according to claim 23, wherein the flame retardant comprises 2 to 20 wt % of an antimonide.

25. The flame-retardant low-resilience urethane foam cushion according to claim 15, wherein the ticking is a flame-blocking pile knit fabric.

26. The flame-retardant low-resilience urethane foam cushion according to claim 15, wherein a flame-blocking knit fabric is provided on an inner side of the ticking.

27. The flame-retardant low-resilience urethane foam cushion according to claim 26, wherein the ticking is a pile knit fabric, and a flame-blocking knit fabric is provided on an inner side of the ticking.

28. The flame-retardant low-resilience urethane foam cushion according to claim 15, wherein a total of a weight per 1 m² of the ticking that covers the low-resilience urethane foam is not less than 300 g/m².

29. The flame-retardant low-resilience urethane foam cushion according to claim 15, wherein the flame-retardant low-resilience urethane foam cushion has flame retardancy that is expressed by a rate of weight decrease after 6 minutes of not more than 20 wt % determined in an evaluation based on Technical Bulletin 604 of the state of California, U.S.A. (issued in October 2003), which explains a pillow burning test method.

30. The flame-retardant low-resilience urethane foam cushion according to claim 15, wherein the flame-blocking fabric is made of spun yarns.
